(19) United States
(12) Patent Application Publication
(10) Pub. No.: US 2004/0120864 A1
(43) Pub. Date: Jun. 24, 2004

(54) Apparatus for removing acid substances from hot flue gas

(75) Inventor: Chin-Lung Chung, Ping-Tung Hsien (TW)

Correspondence Address: MERCHANT & GOULD PC, P.O. BOX 2903, MINNEAPOLIS, MN, 55402-0903, US

(73) Assignee: China Steel Corporation, Kaohsiung City (TW)

(21) Appl. No.: 10/323,558

(22) Filed: Dec. 18, 2002

(51) Int. Cl. B01D 53/34

(52) U.S. Cl. 422/171; 422/168; 422/172

(57) ABSTRACT

An apparatus for removing acid substances from hot flue gas includes a scrubbing device and a washing screen device. The scrubbing device includes reactors, each having two rows of outlet louvers, two rows of inlet louvers provided on two sides of the outlet louvers, two reagent beds, each being confined by one row of the outlet louvers and one row of the inlet louvers, and each containing a granular reagent, and an outlet channel confined by the rows of the outlet louvers to permit the gas to exit from the reagent beds. The washing screen device is mounted below each of the reactors and is operable so as to vibrate and screen the granular reagent falling thereon so that the granular reagent is retained on the washing screen device while wastes are allowed to pass through the washing screen device.

### BACKGROUND OF THE INVENTION

1. Field of the Invention

The invention relates to an apparatus for removing acid substances from hot flue gas, more particularly to an apparatus for removing acid substances from hot flue gas which can achieve effects, such as enhanced scrubbing efficiency and reduced pollution

2. Description of the Related Art

Two primary types of acid gas removal processes are fixed bed type, such as those disclosed in U.S. Patent Nos. 4,764,348 and 4,663,136, and moving bed type, such as those disclosed in U.S. Pat. Nos. 5,160,708, 4,254,557, and 4,670,226. Both types of processes are used to remove primarily sulfur oxides from flue gas.

Generally, the acid gas removal process is conducted through the chemical reaction between the wet reagent (such as calcium carbonate, magnesium oxides, and the like) and the acid gas. During the reaction process, the reaction products, such as calcium sulfate, calcium sulfite, and magnesium sulfate, will adhere on the reagent, and the reagent has to be refreshed and recycled back to the reactor to form a reaction cycle. The term “reaction”, as used herein refers to a process where the flue gas containing acid gas and particulate matter contacts the reagent, and the acid gas, such as sulfur oxides, in the flue gas will react with the reagent inherently. As a result, the flue gas is de-sulfurized by the reaction and becomes a clean flue gas. The sulfur oxides are absorbed into a water layer formed on the granular reagent and diffuse through the water layer to reach the granular reagent. Reaction products, such as calcium sulfate, are formed and precipitate onto the surface of the granular reagent. The term “refresh” as used herein refers to a process where the reaction products produced during the reaction are separated from the reagent. After the refresh process, the reagent can be re-circulated back to the reactor for reuse. Meanwhile, during the refresh process, the tiny granular reagent smaller than the sieve holes of a screen will also be screened to ensure that all of the reagents coming from the refresh process will be clean. The proper particle size of the granular reagent can minimize the carry-over issue that might occur in this field. The flue gas mixture results from various acid gas producing processes, such as coal-fired power plants and the like, the acid gases contained in the flue gas mixture being primarily sulfur oxides. However, there are several disadvantages of the conventional systems, which are described as follows.

First of all, referring to FIG. 1, in the fixed bed system 1, during the normal reaction process, the flue gas flows into a reactor 13 through an electro precipitator 15, an induced draft fan 14, and an inlet rotary damper 111. In the reactor 13, the flue gas will penetrate through granular reagents 131, and then pass through a screen 17 and an outlet rotary damper 113 to reach a stack 16. During the aforesaid normal reaction process, a refresh inlet rotary damper 112 and a refresh outlet rotary damper 115 are closed. In order to allow the reactor 13 to shift from the reaction process to a refresh process, it is necessary to provide a plurality of reactors 13 and branch pipes 161, 162 for such kind of design. In the refresh process, the inlet rotary damper 111 and the outlet rotary damper 113 are closed first, and a dust collector induced fan 181 is started. The refresh inlet rotary damper 112 and the refresh outlet rotary damper 115 are then opened, followed by the starting of a reverse fan 182. A vibrator 19 installed beneath the screen 17 will start to shake the granular reagents 131, fines captured by the granular reagents 131 will be separated and floated out, and sent to the bag filter 18 via a reverse flow generated by the reverse fan 182 through the refresh outlet rotary damper 115. When the refresh process comes to an end, the vibrator 19 and the reverse fan 182 stop, the refresh inlet rotary damper 112 is closed, the dust collector induced fan 181 stops, and the refresh outlet rotary outlet damper 115 is closed.

To compensate the reagent consumption, some fresh reagents are carried to the reactor 13. The make-up damper 116 will be opened to lead the fresh reagent 131′ down to the reactor 13. After the make-up process, a water spray valve 114 is opened, and water will be sprayed into the reactor 13 through a spray nozzle 12 to wet the reagents 131. Finally, the inlet rotary damper 111 and the outlet rotary damper 113 will be opened again to finish one complete cycle. The main drawback of this fixed bed system 1 resides in that the available amount of the reagent 131 staying on the screen 17 must be limited to avoid adverse effects, including poor permeability and refresh efficiency. As a result, the reaction time for each reactor is required to be short, and the acid gas removal performance will be unsatisfactorily low.

Referring to FIG. 2, in the moving bed system 2, reagents 21 are taken from reactor beds 20 by a twin-shaft screw feeder 231, pass through refresh devices (not shown in this figure), and are then fed back to the top of the reactor beds 20 continuously to accomplish a circulated cycle. There are several inlet chambers 241, which are formed by adjacent inlet louvers 24, and several outlet chambers 251, which are formed by adjacent outlet louvers 25, in the moving bed system 2. The reagents 21, normally granular in shape, fill the reactor beds 20 between the inlet louvers 24 and the outlet louvers 25. The flue gas flows to the inlet chambers 241, passes through the inlet louvers 24, penetrates and reacts with the reagents 21 inside the reactor beds 20, passes through the outlet louvers 25 to the outlet chambers 251, and finally goes to a stack (not shown). One collect box 252 located under the outlet chamber 251 is used to collect the broken reagents 21′, which are carried out from the reactor beds 20 and sent back to the reactor beds 20 through the screw feeder 221. The main problem in this moving bed system 2 is that lots of reagent fines will be generated from the reaction and due to abrasion among the granular reagents 21 during their movement. These fines will cause several serious problems, such as high opacity presented in the stack and high plugging tendency to form bridging as well as clogging. As a result, once the louvers 24, 25 have the plugging problem, the differential pressure across the reactor beds 20 will start going up and will become higher, thereby accelerating the superficial flue gas velocity, and thus causing the reagents 21 to be carried out from the reactor beds 20. Although use of larger size reagents reduces such problems, it cannot solve the problems totally. Meanwhile, use of larger size reagents will sacrifice the removal efficiency, and the reaction surface of the reagent will be reduced as well.

In this field, there is always a desire to maintain the advantages of no fine emission in the fixed bed system and high removal efficiency achieved in the moving bed system, and to avoid all the existing problems in these two systems. This invention is developed under such a background to meet the practical need. It is desirable to provide a scrubbing apparatus to overcome the aforesaid disadvantages of the prior art.

### SUMMARY OF THE INVENTION

Therefore, the object of the present invention is to provide an apparatus for removing acid substances from hot flue gas, which can achieve effects such as enhanced scrubbing efficiency and reduced pollution.

An apparatus for removing acid substances from hot flue gas according to this invention includes a scrubbing device and a washing screen device.

The scrubbing device includes a plurality of reactors. Each of the reactors has two rows of outlet louvers, two rows of inlet louvers provided on two sides of the outlet louvers, two reagent beds, each being confined by one of the rows of the outlet louvers and one of the rows of the inlet louvers, and each containing a granular reagent, and an outlet channel confined by the rows of the outlet louvers to permit the gas to exit from the reagent beds. Each of the reactors further includes a top feed inlet unit disposed above and in fluid communication with both of the reagent beds.

The washing screen device is mounted below each of the reactors and is operable so as to vibrate and Screen the granular reagent falling thereon so that the granular reagent is retained on the washing screen device while wastes are allowed to pass through the washing screen device.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic view of a conventional scrubbing apparatus of fixed bed type for removing acid substances from hot flue gas;

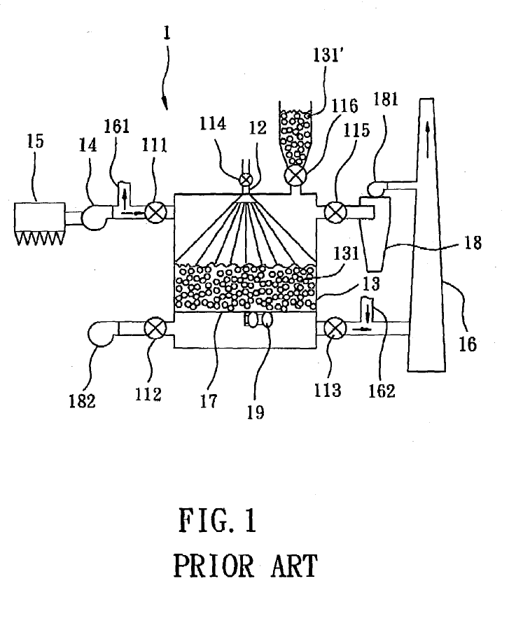

FIG. 2 is a schematic view of a conventional scrubbing apparatus of moving bed type for removing acid substances from hot flue gas;

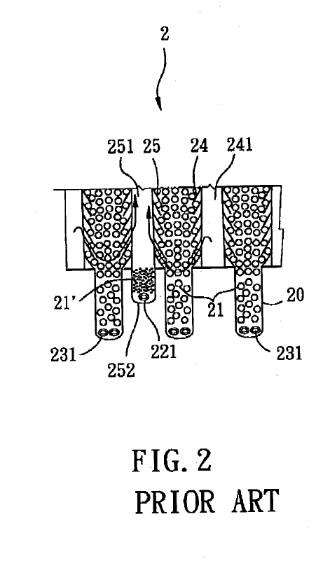

FIG. 3 is a schematic perspective view of the preferred embodiment of the apparatus for removing acid substances from hot flue gas according to this invention;

FIG. 4 is a fragmentary schematic view of the apparatus of the preferred embodiment;

FIG. 5 is an exploded perspective view of a reactor of the apparatus of the preferred embodiment;

FIG. 6 is a fragmentary isometric perspective view showing a scrubbing device and a washing screen device of the apparatus of the preferred embodiment;

FIG. 7 is a fragmentary isometric perspective view of the apparatus of the preferred embodiment;

FIG. 8 is a schematic sectional view of the apparatus of the preferred embodiment, taken along line I-I of FIG. 3;

FIG. 9 is a fragmentary isometric perspective view showing the scrubbing device of the apparatus of the preferred embodiment; and

FIG. 10 is an enlarged view showing the louver of the apparatus of the preferred embodiment.

### DETAILED DESCRIPTION OF THE PREFERRED EMBODIMENT

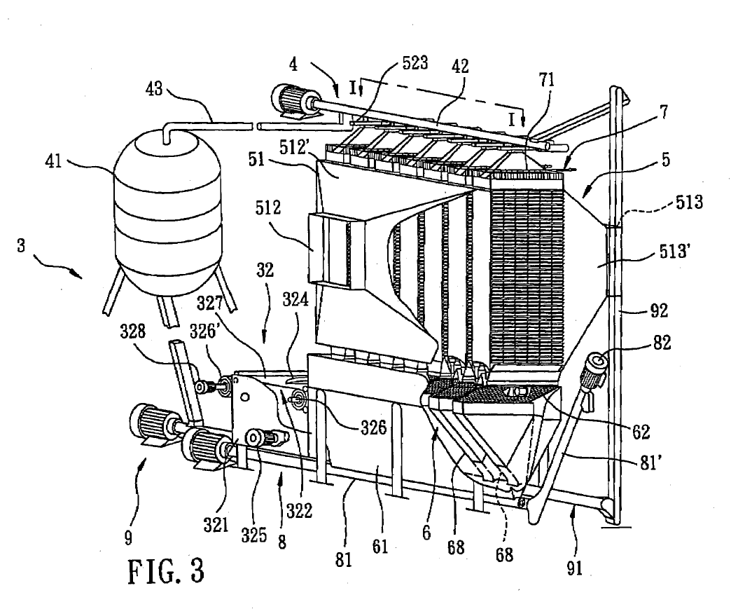

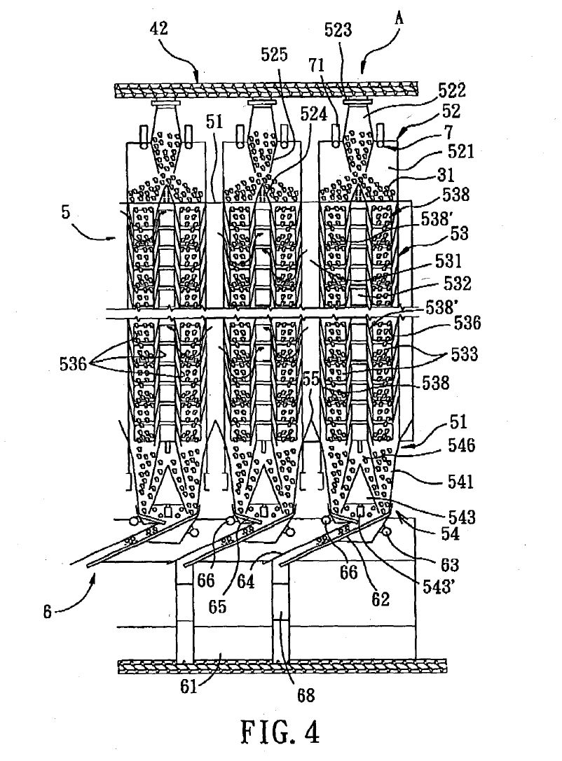

Referring to FIGS. 3 and 4, the apparatus 3 for removing acid substances from hot flue gas according is to this invention is shown to include a feeding device 4, a scrubbing device 5, a shell body 51, a washing screen device 6, a water spraying device 7, a recycle device 9, and a filtering device 32.

The scrubbing device 5 includes a plurality of reactors 53. Each of the reactors 53 has two rows of outlet louvers 538′, two rows of inlet louvers 538 provided on two sides of the outlet louvers 538′, two reagent beds 533, each being confined by one of the rows of the outlet louvers 538′ and one of the rows of the inlet louvers 538, and each containing a granular reagent 31, and an outlet channel 532 confined by the rows of the outlet louvers 538′ to permit the gas to exit from the reagent beds 533. Each of the reactors 53 further includes a top feed inlet unit disposed above and communicated with both of the reagent beds 533. The reagent beds 533 extend in parallel. The reactors 53 are spaced apart from each other to form inlet channels 531 between the inlet louvers 538 of the reactors 53 for passage of the flue gas entering the reagent beds 533 of the reactors 53.

The top feed inlet unit includes a reagent inlet connecting space 52 disposed above and communicated with both of the reagent beds 533, a reagent inlet partition plate 525 that divides the reagent inlet connecting space 52 into a spray chamber 521 and a reagent inlet space 522, an inlet gate valve 523 connected to the reagent inlet space 522, and a sealing plate 524 mounted on top of the outlet channel 532 to block the granular reagent 31 from entering into the outlet channel 532 and to split an inlet stream of the granular reagent 31 into two streams directed to the reagent beds 533.

Referring to FIGS. 4, 6, and 7, the washing screen device 6 is mounted below each of the reactors 53 and is operable so as to vibrate and screen the granular reagent 31 falling thereon so that the granular reagent 31 is retained on the washing screen device 6 while wastes are allowed to pass through the washing screen device 6. The washing screen device 6 includes a primary washing screen 62 and a secondary washing screen 65 which are inclined toward each other while extending downward. The secondary washing screen 65 has a bottom edge. The primary washing screen 62 is longer than the secondary washing screen 65, and extends further to a location lower than the secondary washing screen 65 after extending toward the bottom edge of the secondary washing screen 65. vibrators 63, 66 are connected respectively to the primary and secondary washing screens 62. 65. A guiding plate 64 extends from the bottom edge of the secondary washing screen 65 along the direction of the primary washing screen 62 to receive and guide downward products passing through the secondary washing screen 65 and to prevent the products from going to the primary washing screen 62.

The washing screen device 6 further includes a waste collector 61 for collecting wastes passing through the washing screen device 6, and a recycle collector 68 for collecting the granular reagent 31 retained on the washing screen device 6.

Referring again to FIGS. 3 and 4, the recycle device 9 transports the granular reagent 31 from the recycle collector 68 to the reagent inlet apace 522 of the top feed inlet unit, and includes a recycle screw feeder 91 and a bucket elevator 92 connected to the recycle screw feeder 91.

The shell body 51 surrounds the scrubbing device 5, and includes a front side having a gas inlet opening 512 and a gas inlet plenum 512′, a back side having a gas outlet opening 513 and a gas outlet plenum 513′, and top and bottom walls having openings for penetrating and installing top and bottom ends of the reactors 53. The inlet channels 531 are connected to the gas inlet openings 512. The outlet channel 532 is connected to the gas outlet opening 513.

The feeding device 4 includes a silo 41 for containing the granular reagent 31 therein, and a feeding screw feeder 42 connected to the silo 41 and connected to the reagent inlet space 522 of the top feed inlet unit through the bucket elevator 92. Moreover, the recycle screw feeder 91 of the recycle device 9 is further communicated with the silo 41 of the feeding device 4 so as to transport the granular reagent 31 from the silo 41 to the reagent inlet space 522 of the top feed inlet unit through the recycle screw feeder 91, the bucket elevator 92, and the feeding screw feeder 42. The feeding device 4 further includes an overflow-recovering member 43 for recovering the scrubbing particles 31 overflowing from the reagent inlet space 522 of the reactor 53.

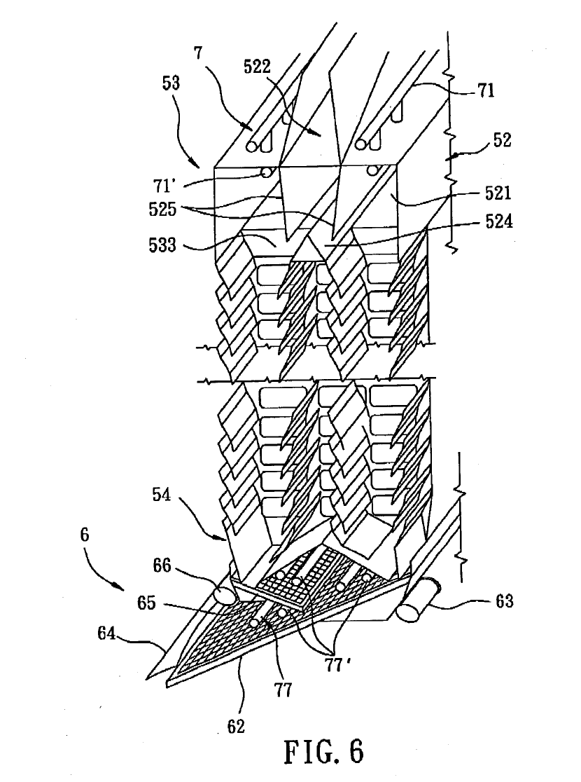

Referring again to FIG. 6, the water spraying device 7 includes a top water spraying device 71 and a bottom water spraying device 77 in each of the reactors 53. The top water spraying device 71 includes a plurality of water sprayers 71′ mounted on two sides of the reagent inlet space 522. The bottom water spraying device 77 includes a plurality of water sprayers 77′ disposed above the washing screen device 6 for spraying water onto the granular reagent 31 on the washing screen device 6.

Referring again to FIG. 4, the scrubbing device 5 further includes a connection space 54 mounted between one of the reactors 53 and the washing screen device 6. The connection space 54 includes two outlet ducts 541 respectively disposed below the reagent beds 533 to serve as the outlet for the granular reagent 31, and an intermediate passage 546 communicated with the outlet channel 532 and disposed between the outlet ducts 541 for passage of the granular reagent 31 from the outlet louvers 538′. The connection space 54 further includes an adjustable reverse V-shaped plate 543 mounted within the intermediate passage 546 to control flow of the granular reagent 31 to the washing screen device 6. The V-shaped plate 543 is movable upward and downward while vibrating under the control of a hydraulically actuated vibrator 543′. Furthermore, the scrubbing device 5 also includes guide plates 55 provided respectively below the inlet channels 531 for guiding fly ash to the outlet ducts 541.

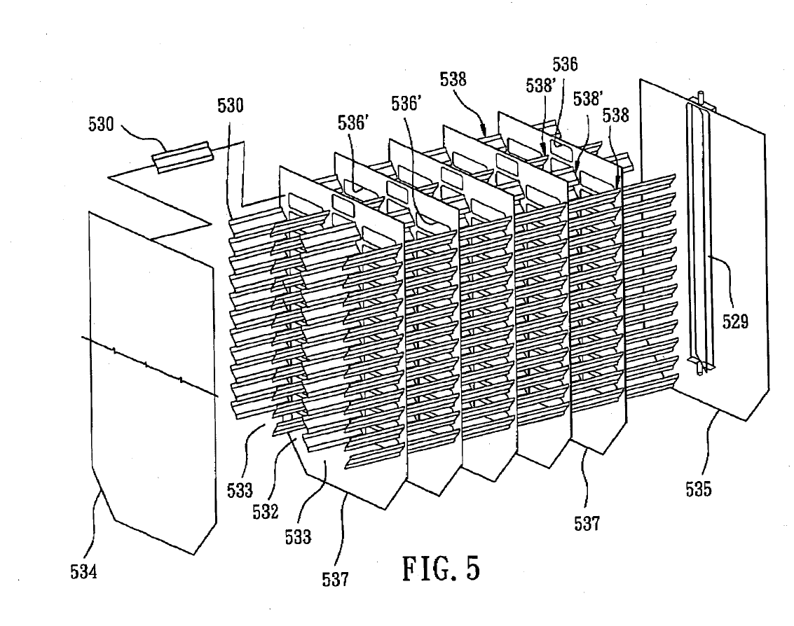

Referring to FIGS. 3 and 5, each of the reactors 53 further includes a first end plate 534 proximate to the gas inlet opening 512 in the shell body 51, a second end plate 535 proximate to the gas outlet opening 513 in the shell body 51, and a plurality of reinforcing partition plates 537 disposed between the first and second end plates 534, 535. The reinforcing partition plates 537 extend across the reagent beds 533, and are disposed transversely of the outlet and inlet louvers 538′, 538 so as to separate the reagent beds 533 into a plurality of reaction fields and so as to reinforce to the reactor 53. Each of the reinforcing partition plates 537 is provided with a plurality of openings 536′ between the reaction fields to permit the granular reagent 31 to flow from one of the reaction fields to another one of the reaction fields, and a plurality of openings 536 between the reagent beds 533 to permit the flue gas to pass through the reinforced partition plates 537. The second end plate 535 is provided with a flue gas outlet damper 529 for controlling flow of the flue gas out of the reactor 53.

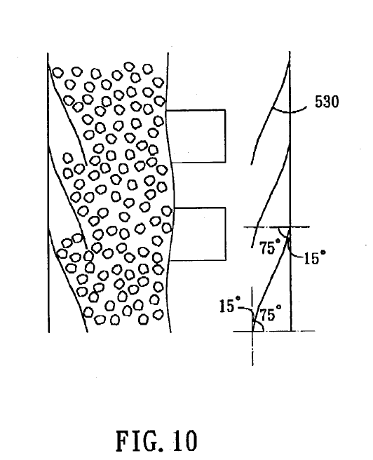

Referring to FIGS. 5 and 10, furthermore, each of the rows of the outlet and inlet louvers 538′, 538 includes a plurality of louver boards 530 spaced apart from each other in an inclined manner. Each of the louver boards 530 includes a top fragment, a middle fragment, and a bottom fragment. The middle fragment inclines with respect to a vertical line. The top fragment inclines upward from the middle fragment. The bottom fragment inclines downward from the middle fragment. The bottom fragment of each of the louver boards 530 extends to a point lower than a top end of the top fragment of a lower one of the louver boards 530.

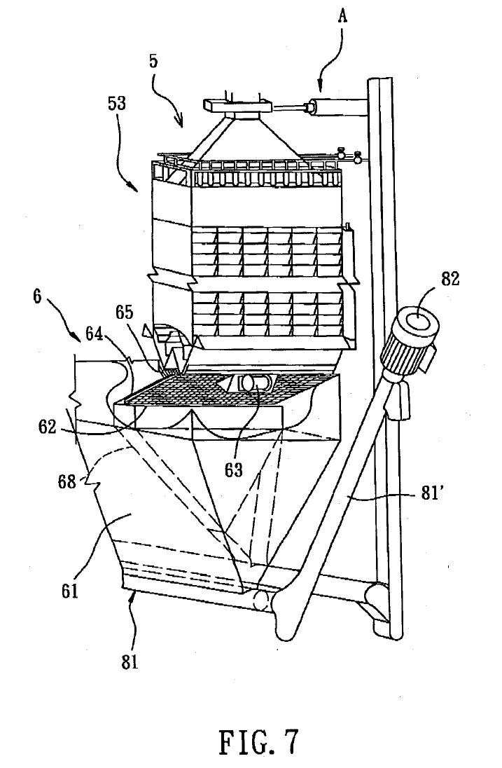

Referring again to FIGS. 3 and 7, a horizontal waste screw feeder 81 and an upward oblique waste screw feeder 81′ connected to the horizontal waste screw feeder 81 are provided to communicate with the waste collector 61 for taking out wastes from the waste collector 61. The upward oblique waste screw feeder 81′ is provided with an opening 82 located higher than the level of the waste contained in the waste collector 61.

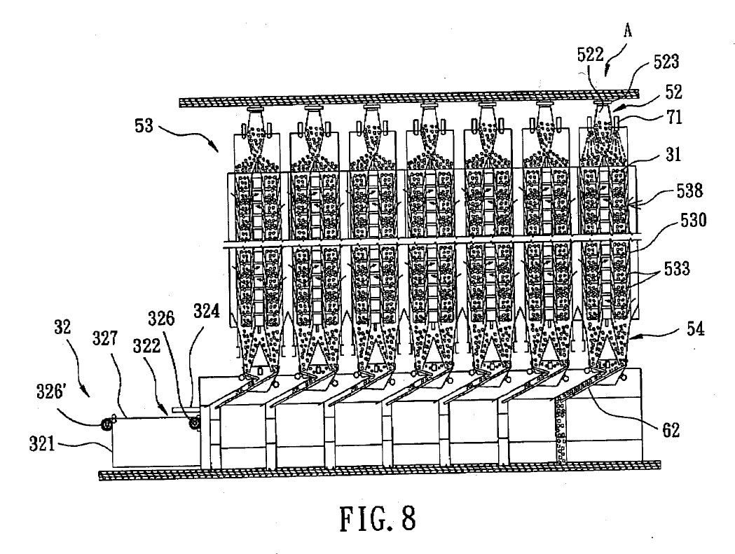

Referring to FIGS. 3 and 8, the filtering device 32 includes a filtrate tank 321 connected to the waste screw feeder 81, a filter cloth device 322 mounted above the filtrate tank 321, an overflow guide plate 324 connected to the waste collector 61 for guiding an overflow from the waste collector 61 to the filter cloth device 322, and a pump 325 for recycling waste effluent from the filtrate tank 321. The filtering cloth device 322 includes a cloth roll 326, a wind-up roll 326′ mounted oppositely above the filtrate tank 321, and a filter cloth 327 moving between the cloth roll 326 and the wind-up roll 326′.

The operation of the apparatus 3 according to this invention will now be described as follows. Usually, the operation includes the processes consisting essentially of initial reagent filling, reagent totally emptying out, normal reaction, refresh and make up, waste collection, and clean reagent re-circulation. Referring to FIGS. 3, 4, and 9, in the initial reagent filling process, there are several reactors 53 in the apparatus 3 according to this invention to he filled. The initial reagent filling process is arranged to fill each reactor 53 one at a time. Taking the reactor labeled “A” as an example, the flue gas outlet damper 529 is closed first, the inlet gate valve 523 is opened, and the feeding screw feeder 42, the bucket elevator 92, and the recycle screw feeder 91 are also started. A bottom gate valve (not shown in the figures) at the silo 41 is then opened so as to cause the reagents 31 to flow to the reactor “A” through the recycle screw feeder 91, the bucket elevator 92, the feeding screw feeder 42, and the inlet gate valve 523. Once the reagents 31 flow into the reactor “A”, they will enter the reagent inlet space 522 first, and then stay inside the reagent beds 533. When a proper level of the reagents 31 has been reached in the reactor “A”, the reagent filling process in reactor “A” is stopped. When stopping the initial reagent filling process of reactor “A”, the inlet gate valve 523 is closed, and the flue gas outlet damper 529 is opened. At this moment, reactor “A” is ready to work. The aforesaid initial reagent filling process can be repeated one at a time until all of the reactors 53 are filled with the reagents 31.

At the end of the filling process, the bottom gate valve of the silo 41 is closed first to stop the flow of the reagents 31, and the recycle screw feeder 91, the bucket elevator 92, and the feeding screw feeder 42 are stopped. The initial reagent filling process can be done without shutting down the acid gas producers, such as boilers, because the tilling process for each of the reactors 53 is isolated from the flue gas stream so that there is no chance to cause the problems of carrying over fine reagents and escalating the opacity.

When internal maintenance and inspection of the reactor is required, the reagents 31 are required to be totally emptied out. Referring again to FIGS. 3, 4, 8 and 9, taking the reactor “A” as an example, the flue gas outlet damper 529 of the reactor “A” is closed first, the feeding screw feeder 42, the bucket elevator 92, and the recycle screw feeder 91 are started. The top water spraying device 71 is opened to flood the granular reagents 31 inside the two reagent beds 533. Meanwhile, the bottom water spraying device 77 is opened to start spraying water so as to perform the washing and separating duties. Thereafter, the vibrators 63, 66 are started, and the reagents 31 will begin to flow out through the primary washing screen 62 and the secondary washing screen 65. All of the re-useable clean granular reagents 31 will fall down to the recycle collector 68, which is installed at the low discharge end of the primary washing screen 62. In here, the used but clean granular reagents 31 will pass through the recycle screw feeder 9l, the bucket elevator 92, and the feeding screw feeder 42, and will finally be sent to the silo 41 through the overflow-recovering member 43. When referring to the emptying process, the reagents 31 inside the connection piece 54 should be maintained therein, and should not be emptied out in any case when the acid gas producing process is still in operation so as to provide a bottom sealing to avoid occurrence of leaks. When the reactor “A” is already emptied out, the moving out process will stop, which starts from stopping the vibrators 63, 66, closing the top and bottom water spraying devices 71, 77, and opening the flue gas outlet damper 529. Following the aforesaid sequence, all of the other reactors 53 will perform the emptying out process until all of the reactors 53 have been emptied. Then, the moving out process can be stopped. When stopping the moving out process, it is designed to stop the recycle screw feeder 91, the bucket elevator 92 and the feeding screw feeder 42. It is noted that the moving out process can be carried out while the acid gas producers, such as the boilers, are in normal running condition because the moving out process for each of the reactors 53 is isolated from the flue gas stream so that there is no chance to cause the problems of carrying over fine reagents and escalating the opacity.

Referring again to FIGS. 3, 4, 6 and 9, in normal reaction process, the flue gas outlet dampers 529 of the reactors 53 are all opened to let the flue gas to go through the reagent beds 533 so as to conduct the inter-reaction between the acid gases in the flue gas and the granular reagents 31. The flue gas enters from the gas inlet opening 512 into the inlet channels 531 through the gas inlet plenum 512′. All of the top and bottom water spraying devices 71, 77 are closed. All of the vibrators 63, 66 of the primary and secondary washing screens 62, 65 are also stopped. Specifically referring to FIG. 4, the flue gas entering into the inlet channels 531 passes through the inlet louvers 538, and enters into the reagent beds 533 where the so-called SOx removing reaction will take place. After the reaction, the clean flue gas will be drawn by a boiler induced draft fan (not shown in the figures) to a stack (not shown in the figures) through the outlet louvers 538′, the outlet channel 532, the flue gas outlet damper 529, the gas outlet plenum 513′, and the gas outlet opening 513.

When the flue gas enters the inlet channels 531 and goes to the inlet louvers 538, some fly ash will be separated from the flue gas stream due to the abrupt change in the flue gas direction. The fly ash will fall into the bottom of the inlet channels 531, and will be introduced to the outlet ducts 541 by way of the guide plates 55.

The reagents 31 are in steady state in the normal reaction process. This is very important because it can minimize the problems such as the production and carrying over of the reagent fines as well as the high opacity. However, when the flue gas passes through the reagent beds 533, few reagents 31 still have the possibility of being carried out of the reagent beds 533 by the flue gas into the outlet channel 532. Due to several reasons, such as gravity force, lower gas velocity and gas flow direction change, some heavier granular reagents 31 will fall down to the intermediate passage 546 of the connection space 54, and will stay therein until the refresh process is conducted for the reactors 53. The heavier granular reagents 31 can be moved out then.

After a period of reaction time, the reactors 53 are required to conduct the refreshing process. In this invention, only one reactor 53 will conduct the refreshing process from the normal reaction process at any given time. In refresh process, the flue gas outlet damper 529 is closed first to isolate the reactor 53 form the main flue gas stream. Then, the inlet gate valve 523 is opened, and the feeding screw feeder 42, the bucket elevator 92 and the recycle screw feeder 91 are started. The top water spraying device 71 is opened so as to spray a large amount of water to flood the reagents 31 thoroughly. The purpose of this is to destroy any possible bridging and plugging that might happen inside the reagent beds 533, and to flood the reagents 31 and the reagent fines into the primary and secondary washing screens 62, 65. In the bottom of the reactors 53, the bottom water spraying devices 77 of the primary and secondary washing screens 62, 65 are opened, and the vibrators 63, 66 of the primary and secondary washing screens 62, 65 are started. Once the vibrators 63, 66 have been started, the reagents 31 staying inside the reagent beds 533 will start to slide down along the inclined surfaces of the washing screens 62, 65. During the movement of the reagents 31 along the washing screens 62, 65, the granular reagents 31 and the reagent fines are supposed to be separated. Moreover, water sprayed from the bottom water spraying device 77 will assist in the separation. water can also clean the reagents 31 so that they can be as clean as the new fresh ones after this washing and separation process. Furthermore, when the reagents 31 are moving, due to the inter-abrasion of the reagents 31, some product layer outside the reagents 31 can separate and fall off. At this moment, lots of water are sprayed onto the reagents 31 so as to wash and refresh the reagents 31. The cleaned reagents 31 will fall into the recycle collector 68, and are fed back to the reactors 53 through the recycle screw feeder 91, the bucket elevator 92, the feeding screw feeder 42, and the inlet gate valve 523. When the refresh process approaches its end, the recycle screw feeder 91, the bucket elevator 92, the feeding screw feeder 42, and the inlet gate valve 523 are still opened, and the flue gas outlet damper 529 is still closed. At this moment, if the reagent level is lower than expected, the normal reagent make up is required. The bottom gate valve of the silo 41 is opened, and the reagents 31 can be sent to the reactors 53 through the recycle screw feeder 91, the bucket elevator 92, the feeding screw feeder 42, and the inlet gate valve 523.

When the reagents 31 start to slide out, those fly ashes and heavier reagents present in the bottom of the inlet channels 531 and the intermediate passage 546 will also start moving and will be carried to the washing screen device 6. The reagent fines separated from the secondary washing screen 65 will be sent to the waste collector 61 through the guiding plate 64. The reagent fines separated from the primary washing screen 62 will fall down to the waste collector 61 directly. All these waste reagent fines will sediment in the waste collector 61. The horizontal waste screw feeder 81 and the upward oblique waste screw feeder 81′ will take the waste reagent fines out to leave the system. For waste effluent, it will flow to the filter cloth 327 through the overflow guide plate 324. The solid cake collected from the waste effluent will stick on the filter cloth 327, and the used filter cloth 327 with cake will be rolled away by turning the wind-up roll 326′ that is driven by a motor 328. After filtering the cakes out, the waste effluent can be deemed to be re-useable and will be sent to a cooling system by the pump 325 of the filtrate tank 321 for re-circulation to save water consumption in the system.

In view of the aforesaid, the apparatus of this invention can achieve an improvement over the prior art, and also has the following advantages:

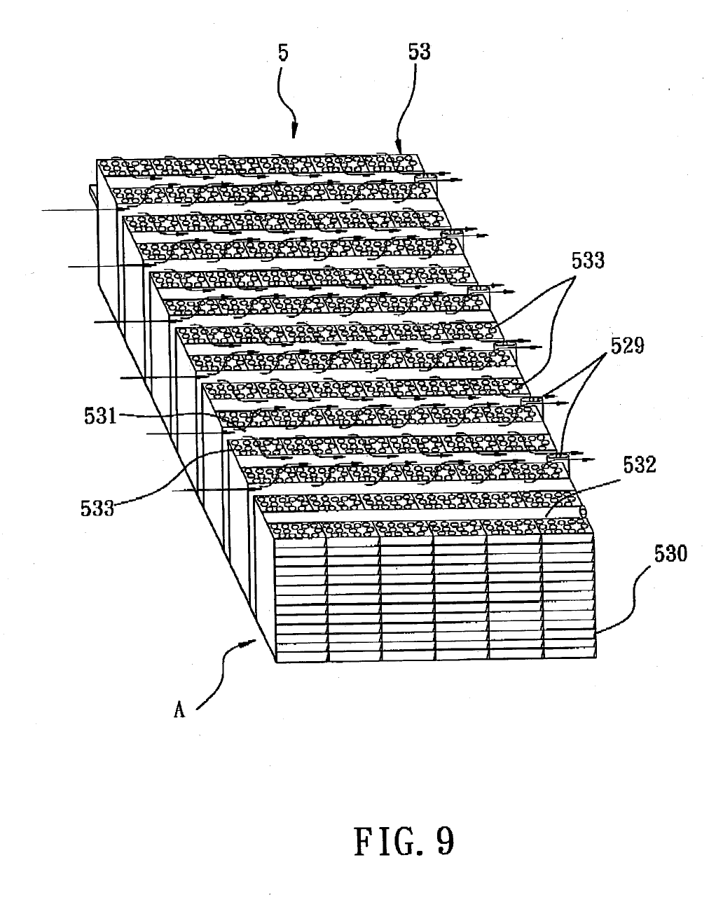

1. Since the granular reagents 31 in the reagent beds 533 of the apparatus 3 of this invention are maintained in a static state during the scrubbing process, the aforesaid shortcomings associated with the conventional apparatus of the moving bed type can be overcome. Furthermore, as shown in FIG. 9, the flue gas passes through the reactors 53 in a direction substantially transverse to the reagent beds 533. Therefore, the aforesaid shortcomings associated with the conventional apparatus of the fixed bed type can also be overcome.

2. The product layer attached to the granular reagents 31 can be easily separated and removed by the cooperation of the water spraying device 7, the vibrators 63, 66, and the inter-abrasion among the moving granular reagents 31 during the refresh process.

3. The bridging shortcoming (i.e., bonding between the granular reagents 31) of the prior art can be avoided by water sprayed by the water spraying device 7 on the granular reagents 31.

4. The provision of the water spraying device 7 in the apparatus 3 of the present invention can achieve the advantages. such as avoiding the formation of powder and fines of the granular reagents 31 which can cause pollution problems, and dampening, cooling and thorough cleaning of the granular reagents 31 during the refresh process so as to simplify the operation.

5. Referring again to FIG. 10, the specific configuration of the louvers 538, 538′ in the apparatus 3 of the present invention can achieve the advantages, such as to enhance the mechanical strength of the louvers 538, 538′, and to prevent the granular reagents 31 in the reagent beds 533 from being carried by the flue gas out of the louvers 538, 538′. This louver design can provide larger flue gas inlet and outlet space than the conventional louver design.

6. The reagent consumption will be less than that of the conventional moving bed system since the reagents 31 are kept in a static state and only move during the refreshing process

7. The flue gas will contact the damp granular reagents 31 directly so that the flue gas temperature can be decreased to achieve better efficiency for the acid gas removal. Furthermore, a pretreatment device is not required in this invention.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. An apparatus for removing acid substances from hot flue gas, comprising:
a scrubbing device including a plurality of reactors, each of which has two rows of outlet louvers, two rows of inlet louvers provided on two sides of said outlet louvers, two reagent beds, each being confined by one of said rows of said outlet louvers and one of said rows of said inlet louvers, and each containing a granular reagent, and an outlet channel confined by said rows of said outlet louvers to permit the gas to exit from said reagent beds, each of said reactors further including a top feed inlet unit disposed above and in fluid communication with both of said reagent beds; and
a washing screen device mounted below each of said reactors and operable so as to vibrate and screen said granular reagent falling thereon so that said granular reagent is retained on said washing screen device while wastes are allowed to pass through said washing screen device.

2. The apparatus as claimed in claim 1, wherein said reagent beds extend in parallel, said reactors being spaced apart from each other to form inlet channels between said inlet louvers of said reactors for passage of the flue gas entering said reagent beds of said reactors.

3. The apparatus as claimed in claim 2, further comprising a shell body surrounding said scrubbing device and including a front side having a gas inlet opening and a gas inlet plenum, a back side having a gas outlet opening and a gas outlet plenum, and top and bottom walls having openings for penetrating and installing top and bottom ends of said reactors, said inlet channels being connected to said gas inlet opening, said outlet channel being connected to said gas outlet opening.

4. The apparatus as claimed in claim 1, wherein said washing screen device further includes a waste collector for collecting wastes passing through said washing screen device, and a recycle collector for collecting the granular reagent retained on said washing screen device.

5. The apparatus as claimed in claim 4, further comprising a recycle device for transporting said granular reagent from said recycle collector to said top feed inlet unit, said recycle device including a recycle screw feeder and a bucket elevator connected to said recycle screw feeder.

6. The apparatus as claimed in claim 1, wherein said top feed inlet unit includes a reagent inlet connecting space disposed above and communicated with both of said reagent beds, a reagent inlet partition plate that divides said reagent inlet connecting space into a spray chamber and a reagent inlet space, an inlet gate valve connected to said reagent inlet space, and a sealing plate mounted on top of said outlet channel to block said granular reagent from entering into said outlet channel and to split an inlet stream of the granular reagent into two streams directed to said reagent beds.

7. The apparatus as claimed in claim 6, further comprising a top water spraying device in each of said reactors, including a plurality of water sprayers mounted on two sides of said reagent inlet space.

8. The apparatus as claimed in claim 1, further comprising a bottom water spraying device in each of said reactors, including a plurality of water sprayers disposed above said washing screen device for spraying water onto said granular reagent on said washing screen device.

9. The apparatus as claimed in claim 5, further comprising a feeding device including a silo for containing said granular reagent therein, and a feeding screw feeder connected to said silo and connected to said top feed inlet unit through said bucket elevator.

10. The apparatus as claimed in claim 9, wherein said recycle screw feeder of said recycle device is further communicated with said silo of said feeding device so as to transport said granular reagent from said silo to said top feed inlet unit through said recycle screw feeder, said bucket elevator, and said feeding screw feeder.

11. The apparatus as claimed in claim 4, further comprising a waste screw feeder communicated with said waste collector for taking out wastes from said waste collector.

12. The apparatus as claimed in claim 11, further comprising a filtrate tank connected to said waste screw feeder, a filter cloth device mounted above said filtrate tank, an overflow guide plate channel connected to said waste collector for guiding an overflow from said waste collector to said filter cloth device, and a pump for recycling waste effluent from said filtrate tank.

13. The apparatus as claimed in claim 12, wherein said filtering cloth device includes a cloth roll, a wind-up roll mounted oppositely above said filtrate tank, and a filter cloth moving between said cloth roll and said wind-up roll.

14. The apparatus as claimed in claim 2, wherein said scrubbing device further includes a connection space mounted between one of said reactors and said washing screen device, said connection space including two outlet ducts respectively disposed below said reagent beds to serve as the outlet for said granular reagent, and an intermediate passage communicated with said outlet channel and disposed between said outlet ducts for passage of said granular reagent from said outlet louvers.

15. The apparatus as claimed in claim 14, wherein said connection space further includes an adjustable reverse V-shaped plate mounted within said intermediate passage to control flow of said granular reagent to said washing screen device, said V-shaped plate being movable upward and downward.

16. The apparatus as claimed in claim 14, wherein said scrubbing device further includes guide plates provided respectively below said inlet channels for guiding fly ash to said outlet ducts.

17. The apparatus as claimed in claim 1, wherein said washing screen device includes a primary washing screen and a secondary washing screen which are inclined toward each other while extending downward, said secondary washing screen having a bottom edge, said primary washing screen being longer than said secondary washing screen and extending further to a location lower than said secondary washing screen after extending toward said bottom edge of said secondary washing screen, vibrators connected respectively to said primary and secondary washing screens, and a guiding plate extending from said bottom edge of said secondary washing screen along the direction of said primary washing screen to receive and guide downward products passing through said secondary washing screen and to prevent the products from going to said primary washing screen.

18. The apparatus as claimed in claim 3, wherein each of said reactors further includes a first end plate proximate to said gas; inlet opening in said shell body, a second end plate proximate to said gas outlet opening in said shell body, and a plurality of reinforcing partition plates disposed between said first and second end plates, said reinforcing partition plates extending across said reagent beds and being disposed transversely of said outlet and inlet louvers so as to separate said reagent beds into a plurality of reaction fields and so as to reinforce said reactor, each of said reinforcing partition plates being provided with a plurality of openings between said reaction fields to permit the granular reagent to flow from one of said reaction fields to another one of said reaction fields, and a plurality of openings between said reaction beds to permit the flue gas to pass through said reinforced partition plates.

19. The apparatus as claimed in claim 18, wherein said second end plate is provided with a flue gas outlet damper for controlling flow of the flue gas out of said reactor.

20. The apparatus as claimed in claim 1, wherein each of said rows of said outlet and inlet louvers includes a plurality of louver boards spaced apart from each other in an inclined manner, each of said louver boards including a top fragment, a middle fragment, and a bottom fragment, said middle fragment inclining with respect to a vertical line, said top fragment inclining upward from said middle fragment, said bottom fragment inclining downward from said middle fragment, said bottom fragment of each of said louver boards extending to a point lower than a top end of said top fragment of a lower one of said louver boards.
